(19) United States
(12) Patent Application Publication
(10) Pub. No.: US 2026/0300701 A1
(43) Pub. Date: Oct. 1, 2026

(54) INTRA-LAYER MIXED PRECISION QUANTIZATION FOR NEURAL NETWORKS

(71) Applicant: Amazon Technologies, Inc., Seattle, WA (US)

(72) Inventors: Julian Faraone, San Francisco, CA (US); Qiuwen Lou, Mountain View, CA (US); Sankalp Dayal, San Mateo, CA (US)

(21) Appl. No.: 19/096,233

(22) Filed: Mar. 31, 2025

(51) Int. Cl. G06N 3/0495; G06F 17/16; G06N 3/048

(52) U.S. Cl. CPC G06N 3/0495; G06F 17/16; G06N 3/048

(57) ABSTRACT

Devices and techniques are generally described for intra-layer mixed precision quantization. In some examples, a first activation matrix comprising a plurality of rows may be computed. A set of outlier rows may be determined from the first activation matrix. A set of non-outliers may be determined from the first activation matrix. A first quantization algorithm may be selected for the set of outlier rows. A second quantization algorithm may be selected for the set of non-outlier rows. A first quantized activation matrix may be generated using the first quantization algorithm and the second quantization algorithm. A second activation matrix for a second layer of the neural network may be computed using the first quantized activation matrix and a first weight matrix.

### BACKGROUND

Machine learning techniques are used to form predictions, solve problems, recognize objects in image data for classification, etc. For example, machine learning techniques may be used to detect objects represented in image data, generate text, images, translate text from one human understandable language to another, etc. In various examples, machine learning models may be improved over time by retraining the models as more or different data becomes available. Accordingly, machine learning techniques are adaptive to changing conditions. Deep learning algorithms, such as neural networks, are sometimes used to detect patterns in data and/or perform tasks.

### BRIEF DESCRIPTION OF DRAWINGS

FIG. 1 is a block diagram of an example machine learning accelerator architecture that may perform intra-layer mixed precision quantization, according to various examples of the present disclosure.

FIG. 2A is a block diagram of an example implementation for intra-layer mixed precision activation matrix quantization, according to various examples of the present disclosure.

FIG. 2B is a block diagram of an example implementation for reordered intra-layer mixed precision activation matrix quantization, according to various examples of the present disclosure.

FIG. 3 depicts an example process for matrix mixed quantization, in accordance with various examples of the present disclosure.

FIG. 4 depicts an example process for generating a quantized activation matrix including mixed precision data, in accordance with various aspects of the present disclosure.

FIG. 5 is a block diagram showing an example architecture of a network-connected device that may be used in accordance with various aspects described herein.

FIG. 6 depicts an example implementation of a neural processing unit of FIG. 1, in accordance with various aspects of the present disclosure.

### DETAILED DESCRIPTION

In the following description, reference is made to the accompanying drawings that illustrate several examples of the present invention. It is understood that other examples may be utilized, and various operational changes may be made without departing from the scope of the present disclosure. The following detailed description is not to be taken in a limiting sense, and the scope of the embodiments of the present invention is defined only by the claims of the issued patent.

Artificial intelligence systems including various machine learning models are currently being developed and deployed for a wide variety of use cases, including generative models such as language models (e.g., large language models (LLMs)), image/video generation models (e.g., latent diffusion models), computer vision models, LLM-based agents, neural network-based classifiers, etc. Such machine learning models may conduct various computations on input data to produce an output, using learned stored weights and biases. The weights and biases may be learned through the training process and stored in the system memory of a device running a machine learning model. For example, neural networks comprising multiple hidden layers may use the stored weights and biases in the computation of activation values for each layer. As such the neural network may involve the repeated manipulation of large quantities of data representing tensors. The term tensor will sometimes be used herein in accord with its mathematical meaning but will also sometimes be used herein to refer to stored data representing a tensor or data structure storing data representing a tensor, e.g., a vector, matrix, or larger dimensional data structure. The term channel will sometimes be used herein to refer to a mathematically defined portion of a tensor, e.g. for a three dimensional tensor characterized as having rows, columns, and sheets (the term sheet is used here instead of the sometimes used term “channel” to avoid confusion), the term channel may refer to a row of a single sheet, a row of all sheets, a column of a single sheet, or a column of all sheets.

In various examples, during inference processing for neural networks data representing weights of the neural network (e.g., the model's parameter set, learned during training) into volatile memory (e.g., static random access memory (SRAM)) for processing by a compute engine (e.g., an engine that performs matrix multiplication, vector multiplication, and/or accumulation of the results). Neural networks and/or other machine learning models may use any number of layers (depending on the specific model being deployed), with each layer potentially having a number of nodes (sometimes referred to as “neurons”). In addition, the nodes in a given layer may be “connected” with nodes in preceding layers, subsequent layers, and/or other layers (e.g., “skip” connections). Each of these connections may be associated with a model weight that may be learned during training. For example, large language models (LLMs) currently employ between a billion and nearly two trillion parameters (e.g., weights and biases) and the number of parameters may continue to expand as new models are developed and trained. The parameters, such as weights and biases, are used in the computation of activation values that are calculated for each node in the layer. The activation values from a layer are then used as the input into the subsequent layer in the neural network and/or other machine learning models. As such, execution of a given machine learning model may require the temporary storage and processing of a large number of activation values. If these generated activation values are stored and subsequently processed in full-precision (e.g., using floating point 16 (FP16) data format) the amount of memory required to store the activations may be very large and unfeasible on personal devices (e.g., laptop computers, mobile phones, etc.). Alongside the memory constraints, processing the activation values in full-precision may require a much more intensive computational processing for each layer contained within the neural network. Additionally, loading full-precision weights and/or activations into on-device memory for processing may consume a large amount of memory bandwidth, which may, in some cases, constrain the model's overall latency. For these reasons, the performance of large machine learning models (such as LLMs) may be described as being “memory bound.”

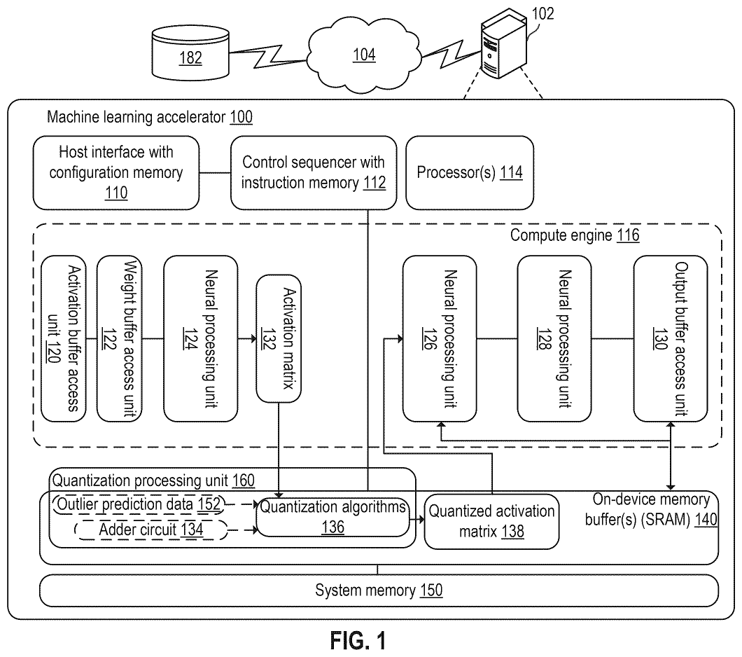

In addition to the large storage requirements for full-precision activation and/or weights values, many hardware accelerators (e.g., neural network accelerators (NNAs) such as described below in reference to FIG. 1) generate an activation tensor for each layer of a neural network and store the activation tensor in memory (e.g., SRAM and/or dynamic random access memory (DRAM) (e.g., if the SRAM is full)) until the activation matrix is required for computation of the next layer in the neural network. As such, loading full-precision activation tensors from memory (e.g., SRAM) into the neural processing unit (NPU) for compute may involve the movement of a large amount of data leading to both significant processing and power consumption by the NNA, as well as the memory bandwidth issues described above. Accordingly, it may be advantageous to compress the activation values for each layer prior to sending the activation tensor for the computation of the subsequent layer. For example, if a full-precision activation tensor is in FP16 format, each activation has a bitwidth of 16 bits, whereas a reduced-precision activation score (e.g., a quantized activation score) may be 8 bits, 6 bits, 4 bits, etc.

Some conventional approaches may compress tensors as a whole. However, model performance has been shown to suffer (when evaluated using common benchmark tests) when quantizing complete activation and/or weight tensors to low bitwidths (e.g., 2-4 bits). The low bitwidth tensors-while allowing for more efficient storage and movement through a data path also have shown to reduce the performance of the model (e.g., model accuracy and other performance characteristics measured using common key performance indicators (KPIs)). Accordingly, there is a tradeoff between quantizing the model activations and/or weights to low bitwidths and the performance of the model. Specifically, while lower bitwidths lead to lower storage requirements, lower computational requirements, and/or improved memory bandwidth, lower bitwidths also may result in degraded model performance (relative to higher bitwidth weights and/or activations).

Some machine learning models, such as neural networks may exhibit outlier values in various values generated and/or used by the model during inference, including tensors of activations and weights. Outlier values are values that differ significantly from other data points in the sample. Various statistical methods may be used to quantify outliers. For example, Z-scores, interquartile range (IQR), median absolute deviation, etc., may be used to identify outliers based on the data distribution. Outlier values may be further skewed by nonlinear activation functions present in LLMs and/or other models (e.g., SoftMax) that push such values further apart. For example, in SoftMax, the exponential function in the numerator results in positive outliers skewing the distribution of the output tensor. If the largest value in the input is very large, the outputs corresponding to negative and small positive numbers may all be mapped to 0 at the (uniformly) quantized output (especially for low bit quantization). This can negatively affect the accuracy of the quantized model with quantized activations (e.g., where input and outputs of SoftMax are quantized). Outlier values in an activation matrix may be more influential in the computation of the next layer of the neural network than non-outlier values.

As such it may be beneficial for an activation and/or weight tensor to be quantized to different levels depending on the classification of the values of a given node as an outlier or non-outlier. Various approaches, described herein, may be used for intra-layer mixed precision quantization. Intra-layer mixed precision quantization refers to quantizing activation and/or weight tensors to generate multiple different compression levels within a quantized tensor. In various examples, outlier rows may be determined for activation and/or weight tensors based on the presence of outlier values within the row. For example, an activation tensor comprising four rows the first two rows may be determined to be outlier rows and compressed using a quantization algorithm that converts FP16 to 8-bit integer format. The second two rows may be determined to be non-outlier rows and compressed using a quantization algorithm that converts FP16 to 4-bit integer format. The benefit of intra-layer mixed precision quantization is that values that may be influential (e.g., outliers) in the subsequent processing may be compressed less than activation values that may not be influential (e.g., non-outliers) in the subsequent processing, which may be compressed more. The intra-layer mixed precision quantization process may improve model performance over traditional full tensor quantization techniques by generating higher bitwidth quantized outlier values, which may include more information relative to lower bitwidth quantized outlier values. The intra-layer mixed precision quantization process may reduce the volume of data contained within a quantized tensor by selectively generating lower bitwidth quantized non-outlier values whose accuracy may not be as important for the model performance. The intra-layer mixed precision quantization process may use different quantization algorithms on outlier and non-outlier rows which may reduce the underflow of smaller values caused by the inclusion of larger values in the data set being quantized. Previous techniques designed to reduce underflow in full tensor quantization may include clipping of outlier values to a set maximum value designed to mitigate underflow. However, such methods may compromise model performance by limiting the outlier values. Intra-layer mixed precision quantization may reduce the underflow of non-outlier values without clipping the outlier values by using separate quantization algorithms and, as such, the potential range of values may be lower. As such, intra-layer mixed precision quantization may reduce the memory footprint of a model, while conserving memory bandwidth, without the corresponding model performance degradation typically associated with model quantization.

Many of the examples discussed herein describe quantization of two-dimensional matrices. However, it should be appreciated that these techniques can be extended to higher-dimensional data structures such as tensors, etc. For example, a three-dimensional tensor comprising N channels could be considered N matrices that each may undergo intra-layer mixed precision quantization.

Intra-layer mixed precision quantization can use various different quantization algorithms, as described in further details below. The different quantization algorithms may be implemented on different rows within activation and/or weight tensors. Additionally, the rows of the activation and/or weight tensor may be reordered prior to quantization to allow for better efficiency in the quantization process. The rows selected for low bitwidth quantization may be grouped together. Similarly, rows selected for higher bitwidth quantization may be grouped together in a reordered tensor. The reordering of the activation matrix by grouping of rows may also allow for the different groups of rows to be sent through specific memory buses from the SRAM to the NPU based on the bitwidth of the quantized values, improving efficiency.

The various machine learning models described herein may be executed on a combination of physical and/or virtualized computing devices/resources. Physical computing resources may include, for example, hardware compute processing units (CPUs), hardware accelerators (e.g., graphics processing units (GPUs), neural processing units (NPUs), neural network accelerators (NNAs), physical memory, etc. Examples of virtualized computing resources may include virtualized CPUs, GPUs, NNAs, virtual memory, etc. Computing resources may include virtualized components executing on physical hardware. In some examples, the virtualized components and/or the physical hardware on which the virtualized components are executed may be distributed (e.g., geographically diverse). A collection of distributed compute services (e.g., of a given server instance) may be instantiated, for example, using a container orchestration framework, one or more virtual machines, physical hardware, etc. In some other examples, a given server instance may be executed on the same hardware components (and may not be distributed). Accordingly, server instances may include components that are physical and/or virtual and which may be distributed and/or co-located. A configuration for a given server instance can refer to the different hardware (whether physical or virtualized) deployed on the server instance, the software deployed on the server instance, and/or the configurations thereof.

In various examples discussed herein, some of the computing devices described herein may be provisioned with and/or may employ accelerator hardware. In some cases, machine learning accelerators (and/or general processors, depending on the implementation) may be programmed to implement an inference engine (sometimes called a “compute engine”). An inference engine refers to programming a machine learning accelerator and/or general purpose processor (or processors) to execute the various operations of a particular machine learning model. Examples of such operations may include determining dot products of two vectors, vector addition, vector multiplication, matrix multiplication, forward and backward convolutions, pooling, etc. Inference engines may be implemented using machine learning accelerator hardware and/or other specialized processors (e.g., graphical processing units, tensor processing units).

Hardware accelerators may include a class of specialized hardware accelerators designed to accelerate machine learning applications by focusing on arithmetic operations and in-memory (e.g., in SRAM) computing capability. A neural network accelerator (NNA) architecture is an example of a machine learning accelerator hardware that has been designed to accelerate processing for neural networks. An example of an NNA is described below in reference to FIG. 1. A variety of different operations may be performed by a particular machine learning model during inference. As an example of machine learning operations (e.g., operations that may be optimized to improve performance using the various hardware and/or techniques described herein), a forward pass of a feed forward neural network is now described.

The forward pass involves a series of mathematical transformations that start at the input layer, propagate through one or more hidden layers, and culminate in the output layer. Input data, usually in the form of vectors (e.g., a numerical encoding of one or more inputs token representing words or sub-words, in the context of language models), is provided to the input layer of the model. In a fully-connected example, each node of the input layer is connected to each node of the subsequent first hidden layer. For each node of the input layer, the value is multiplied by a respective weight (a parameter learned during training). The weight value for a given input node is specific to that node's connection with a given node in the first hidden layer. For a given node in the first hidden layer, the weighted inputs are summed together, and a bias term is added. The bias term allows the activation function to be shifted to the left or right (e.g., to be more negative or more positive). This summation result may be passed through an activation function (e.g., sigmoid, a rectified linear units (ReLu) function, tanh, etc.) to introduce non-linearity into the model. The resulting value is the activation score for the first node in the first hidden layer. This process is repeated for each node in the first hidden layer. The activation score for the first hidden layer may be provided as the input to the second hidden layer and so on. Note that the weight values connecting nodes in the input layer may be different for each distinct node in the first hidden layer (and similarly for the connections between subsequent hidden layers and the output layer).

The activation values for the nodes in the first hidden layer (and similarly for any hidden layer and the output layer) may be stored together in a data structure referred to herein as an activation tensor. In an activation tensor, each element may correspond to a node and the value of that element may be the current activation value for that node (generated for the current input). Since the inputs may be dynamic, these activation values change over time and are thus dynamic. However, activation values (and activation vectors, matrices, and/or tensors) may be compressed and/or quantized, as described herein.

As previously described, some neural networks comprise hidden layers that each generate an activation matrix comprising respective activation values from nodes included in the layer. As such, using an activation matrix comprising this data may require a large amount of data moving in and out of memory (e.g., SRAM). The various intra-layer mixed quantization methods described herein may reduce the amount of data that is required to be moved, by selectively quantizing rows by various degrees to reduce the data volume, while maintaining accuracy (and/or reducing performance degradation) of the model. The intra-layer mixed precision quantization of the activation matrix occurring between layers may also reduce the complexity of the computations conducted by the next layer. The system may dynamically determine which rows of the activation matrix contain activation values that may be influential in the processing of the next layer (such as outlier activation values) and may quantize these rows to a lesser degree than other rows (e.g., rows determined to not include outlier activation values). Conceptually, the intra-layer mixed precision quantization process may quantize and/or compress the data differently based on the importance of a given row in the next step of the computation and/or to the overall model performance. In various examples, the importance of a row within an activation matrix may be determined based on the magnitude of the values that the row contains. As the next layer of the neural network uses the activation matrix from the previous layer multiplied by the weight matrix, larger activation values may have a larger impact on this computation than smaller numbers.

Machine learning techniques, such as those described herein, can be used to form predictions, solve problems, answer questions, recognize objects in image data for classification, generate images, video, and/or natural language data, etc. In various examples, machine learning models may perform better than rule-based systems and may be more adaptable as machine learning models may be improved over time by retraining the models as more and more data becomes available. Accordingly, machine learning techniques can adapt to changing conditions.

Generally, in machine learning models, such as neural networks, after initialization, annotated training data may be used to generate a differentiable cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is sometimes referred to herein as back propagation.

### Language Models

A generative language model (LM) is an artificial intelligence (AI) model that may be capable of processing and generating human-like text based on the latent information it has learned from vast amounts of training data. In some cases, some LMs are referred to as “large” language models (LLMs). The term “large” refers to the size of these models in terms of the number of parameters or weights, which are the values that the model learns during training to make predictions and/or generate output such as text, synthesized speech, control instructions for control of other devices, etc. LMs may have millions, billions (or even more) parameters, which enable such models to capture complex patterns and nuances in language that, in turn, allow the models to process and generate more natural-sounding text (relative to previous approaches). LMs are typically trained on massive datasets that include a wide variety of text from various sources, enabling the LMs to “understand” grammar, context, and the relationships between words, sentences, paragraphs, etc. Examples of LMs include the generative pre-trained transformer models (e.g., GPT-3, GPT-4), Pathways Language Model (PaLM), Large Language Model Meta Artificial Intelligence (LLaMA), Claude by Antrhopic, as well as non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases due to the large amount of latent information the generative LM has learned during training. The term “prompt” may refer to plain text or structured text and may be provided via an interface to the LM, such as an API. The prompt may generally be written in natural language, expressed, for example, as if requesting a task to be performed by the LM (e.g., “Who is the current President of the United States?”). In some examples, contextual information may be provided (e.g., as part of the prompt) and/or may be retrieved (e.g., from external sources) by the LM (e.g., retrieval-augmented generation (RAG)) and used to respond to the prompt). In some examples, LMs may be instructed (e.g., using hidden prompts) as to how to use various external APIs and/or tools (e.g., online search engines and/or other software) that may, in turn, be used to perform actions responsive to user-input requests. LMs are often built using the transformer architecture, which is described in further detail below. It should be noted, however, that transformers may be used in other machine learning contexts beyond LMs.

The foregoing examples of machine learning processing tasks are merely examples to show the diversity (in terms of both the task and the complexity) of machine learning techniques. However, the intra-layer mixed precision quantization hardware and techniques described herein may be used with any machine learning tasks that implement hidden layers for processing. Various examples discussed herein describe example quantization of two-dimensional matrices for illustrative purposes. However, it should be appreciated that these techniques can be extended to other data structures such as tensors, etc.

FIG. 1 is a block diagram of an example machine learning accelerator 100 that may include a quantization processing unit 160 for intra-layer mixed quantization, according to various embodiments of the present disclosure. In various examples, one or more computing devices 102 may include and/or be used to execute the machine learning accelerator 100 and/or components thereof. Additionally, the various components of the one or more computing devices 102 implementing machine learning accelerator 100 may be a collection of compute services that are distributed in a cloud-based environment. The components of machine learning accelerator 100 may communicate with one another and/or with remote computing devices (such as various server instances discussed herein) via a network 104. Network 104 may be a wide area network (WAN), such as the Internet, an intranet, a local area network (LAN), and/or some combination thereof. Non-transitory computer-readable memory 182 may store instructions that, when executed by one or more processors of the one or more computing devices 102 may be effective to instantiate the various components of machine learning accelerator 100 and/or perform the various techniques described herein. In various examples, the machine learning accelerator 100 may include system memory 150 (e.g., DDR, NAND flash, DRAM, etc.) that may store the weight vectors (and/or any other weight data structures such as matrices, tensors, etc.) of one or more trained machine learning models. The terminology “full-precision” as used herein indicates the precision of activation values computed by the compute engine 116. For example, the activation matrix produced by a hidden layer through the computation conducted by the compute engine 116 may contain values in FP16 format.

The machine learning accelerator 100 is one example instantiation of a hardware accelerator that may be used to perform highly-parallelized computations that may be typical of machine learning inference, training, and/or testing (e.g., matrix multiplication, tensor products, etc.). However, it should be noted that other types of accelerator hardware may also be used (and/or may be used in combination with the machine learning accelerator 100) in accordance with the present disclosure. For example, graphics processing units (GPUs), tensor processing units (TPUs), field-programmable gate arrays (FPGAs), neural processing units (NPUs), application-specific integrated circuits (ASICs), inference accelerators, etc., may be used in various server instance configurations described herein.

The machine learning accelerator 100 (e.g., a neural network accelerator, GPU, etc.) comprises a host interface 110, a control sequencer 112, an optional processor 114 (e.g., one or more CPUs with any number of cores), an activation buffer access unit 120, a weight buffer access unit 122, a plurality of neural processing units (NPUs) 124, 126, and 128, an output buffer access unit 130, a set of on-device memory buffers 140, and system memory 150 (e.g., DDR) The activation buffer access unit 120, the weight buffer access unit 122, the NPUs 124, 126, and 128, and the output buffer access unit 130 collectively form a compute engine 116. Along with the control sequencer 112, the compute engine 116 is responsible for executing instructions. Although a neural network accelerator (machine learning accelerator 100) is shown and described in the examples of FIG. 1, the intra-layer mixed precision quantization techniques described herein may be used with any machine learning hardware accelerator and/or with a general purpose processor (e.g., using software).

The machine learning accelerator 100 can be implemented as a standalone computing system or as shown in FIG. 1, as part of a computing system comprising a host processor and system memory 182. The machine learning accelerator 100 depicted in FIG. 1 is merely an example and is not intended to unduly limit the scope of claimed embodiments. One of ordinary skill in the art would recognize many possible variations, alternatives, and modifications. For example, in some implementations, machine learning accelerator 100 may have more or fewer components than those shown in FIG. 1, may combine two or more components, or may have a different configuration or arrangement of components. The machine learning accelerator 100 generally executes one set of instructions at a time. This set of instructions is referred to herein as a “context.” At runtime, the machine learning accelerator 100 sequences and dispatches, using control sequencer 112, instructions from a pre-compiled context for execution. In certain embodiments, each context comprises a set of instructions that ends with a HALT instruction. Contexts are created by a software compiler. The instructions within a context can implement at least part of a neural network. For example, a context can correspond to a complete layer, a partial layer, or multiple layers of the neural network. In some instances, a context can correspond to a complete neural network (e.g., with instructions for an input layer, a hidden layer, and an output layer).

The host interface 110 is a communication interface to the host processor (not depicted) of the computing system. The computing system includes system memory for storing data operated on by the machine learning accelerator 100 (e.g., weights, activations, and output values corresponding to inferences). The machine learning accelerator 100 may be communicatively coupled to multiple hosts simultaneously, with any one of the hosts being able to program the machine learning accelerator 100 to execute neural network-related tasks on behalf of the host. The host interface 110 can communicate with the host processor via a standard communication protocol such as, for example, Advanced eXtensible Interface (AXI) protocol. Similarly, the machine learning accelerator 100 can include a separate communication interface for communicating with the on-device memory buffer(s) 140 and/or the system memory 150, e.g., to read and write data from the on-device memory buffers 140 to the system memory 150.

The control sequencer 112 is responsible for sequencing, dispatching, and finishing execution of instructions. Some instructions are executed entirely in the control sequencer 112. Other instructions may be dispatched to one or more of the NPUs 124, 126, and 128 for execution, possibly with execution results being returned to the control sequencer 112 for further processing. Still other instructions are executed by the quantization processing unit 160 to determine the outlier rows contained within the activation matrix 132 and/or to determine the required quantization levels of the activation matrix 132. More than one instruction can be in the execution phase at any given time within the machine learning accelerator 100. The control sequencer 112 can include an instruction memory into which instructions to be executed by the machine learning accelerator 100 are downloaded from the host processor or loaded from the system memory. In the example of FIG. 1, the host interface 110 includes a configuration memory. The configuration memory may include one or more registers that are configurable by the host processor to specify parameters relating to the context to be executed, e.g., various context dependent parameter registers (CDPRs).

In certain embodiments, the configuration memory includes a predicate register for synchronizing execution of instructions. Instructions are broadcast by the control sequencer 112 to each component of the compute engine 116 as well as the on-device memory buffers 140 and the system memory 150. Upon receipt of a broadcast instruction, a component may proceed to execute at least part of the instruction in response to determining that the component is capable of handling the instruction. For example, the system memory 150 could receive and execute a data move instruction, but the NPUs 124, 126, and 128 could ignore the data move instruction. Because instructions can execute concurrently in different components, it is useful to have a synchronization mechanism to handle any dependencies between instructions. The predicate register can be used to implement such a synchronization mechanism and, in certain embodiments, is a global register visible to internal components of the machine learning accelerator 100, as well as visible to external entities such as the host processor. Synchronization also helps to prevent conflicts in accessing the on-device memory buffers 140.

The processor 114 is an optional general purpose processor for performing certain types of processing in parallel with processing performed by the NPUs 124, 126, and 128. For example, processor 114 may include a floating point unit or other arithmetic logic unit for performing general arithmetic operations in parallel with matrix operations performed by the NPUs 124, 126, and 128.

The activation buffer access unit 120 is configured to access one or more activation buffers in the on-device memory buffers 140. In various examples, the activation buffer access unit 120 may access the on-device memory buffers 140 and may access the quantized activation matrix 138 generated by the quantization processing unit 160.

Similarly, the weight buffer access unit 122 and the output buffer access unit 130 are configured to access one or more weight buffers and one or more output buffers, respectively. The quantized activation matrix 138 stored in the activation buffer(s) correspond to activations produced by one or more layers of a neural network being executed on the machine learning accelerator 100. The weights stored in the weight buffer(s) are synaptic weights (e.g., model parameters) associated with edges between a node of one layer and a node of another layer. In various examples, the weights may be quantized using the intra-layer mixed precision quantization which may be stored in the weight buffers. Activation and weights are used for certain computations, including for instructions executed by the compute engine 116. The output buffers can store final results or intermediate results (e.g., partial sums) for access by the host processor or the system memory 150. The NPUs 124, 126, and 128 perform numerical operations using the activations and weights stored in the on-device memory buffers 140. Each NPU is configured to perform all or part of a compute instruction. Although FIG. 1 depicts the NPUs 124, 126, and 128 as block components, the NPUs 124, 126, and 128 are not necessarily identical. For example, the operations of one NPU may differ from the operations performed by another NPU.

The quantization processing unit 160 may be used to quantized generated activation matrices (e.g., activation matrix 132). The activation matrices (e.g., activation matrix 132) may be generated, for example, by a hidden layer of the neural network being processed by NPU 124. The quantization processing unit 160 may quantize full precision activation matrices (e.g., activation matrix 132). The quantized activation matrix 138 generated by the quantization processing unit 160 may be stored in the on-device memory buffer(s) 140 (e.g., SRAM) until needed for compute (e.g., by a subsequent layer of the neural network). The quantized activation matrix 138 may be accessible to the activation buffer access unit 120 and the NPUs 124, 126, and 128. The quantization activation matrix 138 may be loaded and used in computation of the subsequent hidden layer of the neural network processed by the NPU 124.

In various examples, the location of the quantization processing unit 160 can vary. For example, in another embodiment, the quantization processing unit 160 can be part of the compute engine 116 and is configured to quantize activation matrices stored in the activation buffer, for input of the quantized activation values to one or more of the NPUs, 124, 126, and 128.

The quantization processing unit 160 may use additional data to generate the quantized activation matrix 138. The quantization processing unit 160 may use outlier prediction data 152 to determine the outlier rows of the activation matrix 132. The outlier prediction data 152 may be generated by a machine learning algorithm that may analyze the trained neural network and determine which nodes within each layer of the neural network provide the most influence towards generating a representative output. For example, the machine learning algorithm may predict the rows that provide the greatest influence on the model in the activation matrix generated by the first layer of the neural network, based on their influence on the subsequent layer's nodes. In another example, the outlier prediction data 152 may be generated by an external system running the same neural network as the machine learning accelerator 100. The external system may process example inputs into the neural network and determine from these sample inputs the top rows that may provide the greatest influence on the outcome of the model. The top rows may then be used by the quantization processing unit 160 as a prediction for the outlier rows of the neural network for example, for the first layer of the neural network. The outlier prediction data 152 may be stored internally in the on-device memory buffer(s) 140 (e.g., SRAM) or may be stored externally on associated storage devices accessible by the machine learning accelerator 100 over network 104 (e.g., non-transitory computer-readable memory 182).

In various examples, the quantization processing unit 160 may use the outlier prediction data 152 to determine the outlier rows contained within the activation matrix 132 generated by the NPU 124. The use of the outlier prediction data 152 in the determination of outlier rows may reduce the on-device computation required for the intra-layer mixed precision quantization, removing the need for the machine learning accelerator 100 to compute outlier rows during the processing associated with the neural network. The use of outlier prediction data 152 may improve the processing time by removing the need to compute the outlier rows for each activation matrix generated. However, in some examples, prediction of outlier data 152 may reduce the accuracy of the model (e.g., when such outlier predictions are not accurate). For example, the outlier prediction data 152 may predict the top outlier rows for the activation matrix of the first layer of the neural network based on example inputs seen in the training data relating to answering questions. NPU 124 may generate the activation matrix 132 for the first layer of the neural network based on an input that may be a statement. In this case, the generated matrix may contain outlier rows that are not predicted by the outlier prediction data 152.

In the example of FIG. 1, the quantization processing unit 160 may use the adder circuit 134 to compute the outlier rows of the activation matrix 132. The adder circuit 134 may use the activation matrix 132 to generate the total activation score for each row within the matrix (e.g., by summing the individual activation values in each row). The adder circuit 134 may output a total accumulated activation value for each row. In some examples, the quantization processing unit 160 may determine the outlier rows based on the computed accumulated activation values. For example, the quantization processing unit 160 may rank the rows based on the accumulated activation values of the rows. High ranking rows may be the outliers contained within the activation matrix. In other examples, the adder circuit 134 may be replaced with a comparator circuit that may determine the maximum activation score within each row of the activation matrix 132. The quantization processing unit 160 may use the determined maximum activation score of each row of the activation matrix to determine outlier rows. For example, the comparator circuit may determine the maximum activation score of each row within the activation matrix 132. The comparator circuit may further determine the highest maximum activation row values within the activation matrix 132. The quantization processing unit 160 may use the determined highest maximum activation score rows as the outlier rows. The ability of the quantization processing unit 160 to use the adder circuit 134, comparator and/or other computational methods to determine the outlier rows contained with the activation matrix 132 may allow for accurate outlier determination for activation matrices produced in response to any input. However, the use of the adder circuit 134 and/or a comparator circuit may be omitted if the classification of rows is provided using the outlier prediction data 152.

The quantization processing unit 160 may use the determined or predicted outlier rows in the intra-layer mixed precision quantization. In some examples, the quantization processing unit 160 may select a quantization algorithm for the outlier rows and a different quantization algorithm for the remaining non-outlier rows contained within the activation matrix 132. In some examples, the quantization processing unit 160 may determine, based on instructions, the required bitwidth and data format of the outlier and non-outlier rows of the activation matrix 132 for the subsequent processing of the neural network. The quantization processing unit 160 may select an appropriate quantization algorithm 136 for quantizing the outlier rows based on the required bitwidth (e.g., 8-bit) and the required format (e.g., integer) to generate quantized outlier rows in the required format (e.g., INT8). The quantization processing unit 160 may select an appropriate quantization algorithm 136 for the non-outlier rows based on the required bitwidth (e.g., 4-bit) and the required formation (e.g., integer) to generate quantized non outlier rows in the required format (e.g., INT4). The selected quantization algorithms 136 may generate a quantized activation matrix comprising the quantized outlier rows and the quantized non-outlier rows, which may be stored in the on-device memory buffer(s) (SRAM) 140.

The NPUs 124, 126, and 128 perform numerical arithmetic operations using the quantized activation matrix 138 and weights stored in the on-device memory buffers 140. Each NPU is configured to perform all or part of a compute instruction. The compute instruction may, for example, implement at least some of the computation described earlier in connection with processing by a node of a neural network, i.e., computing a weighted sum of input activation values multiplied by weights, adding a bias value to the weighted sum, and then applying an activation function generating a second activation matrix for the next layer. Other types of computations may also be performed by the NPUs 124, 126, and 128. For example, performing an extended multiply add, subtracting two vectors, and other types of operations applicable to data from a vector or matrix may be performed.

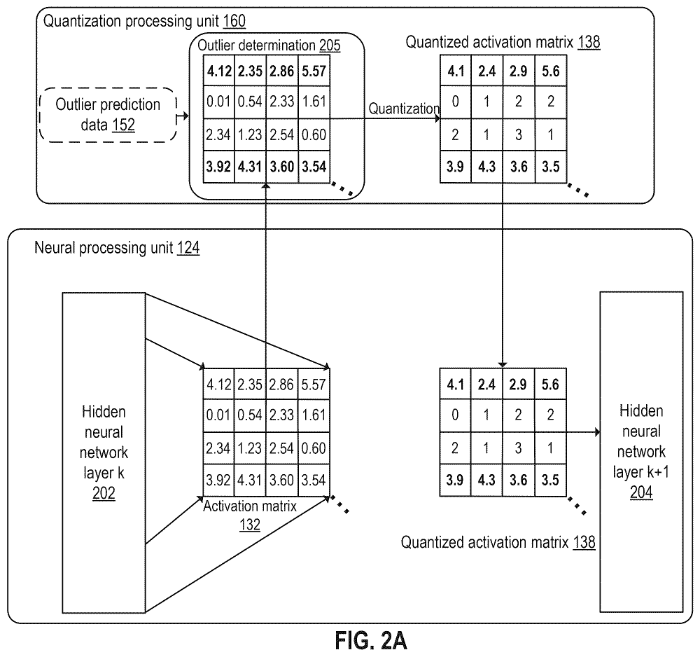

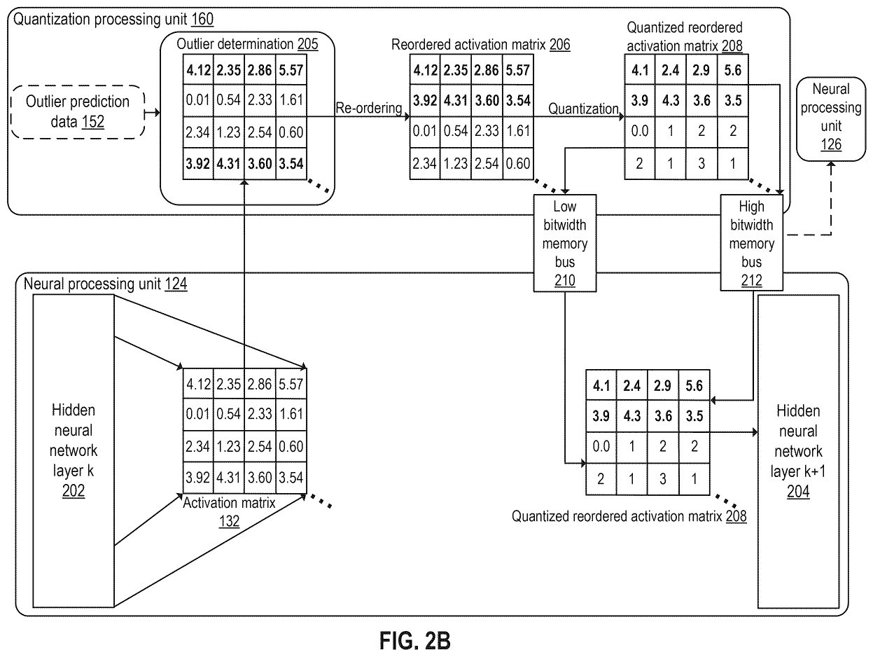

FIG. 2A depicts an example of intra-layer mixed precision quantization that may be used by various systems and techniques of the present disclosure. In the example of FIG. 2A, the NPU 124 may generate activation values by computing node activations for the hidden neural network layer k. In some examples, the activation values may be generated in full precision of the model (e.g., FP16). The activation matrix 132 may be processed by the quantization processing unit 160. In this example, the quantization processing unit 160 may use outlier prediction data to determine the outlier rows during the outlier determination 205 process. It should be noted that other methods (e.g., explicitly computing outliers and/or estimating outliers) may be used for outlier determination in the place of the outlier prediction data 152. The quantization processing unit 160 may select the quantization algorithms that may generate the required bitwidth and data formats required as determined by the instruction set. The quantization processing unit 160 may generate a quantized activation matrix 138 using the selected quantization algorithms. In this example, the determined outlier rows are quantized from two-decimal places down to one-decimal place and the non-outlier rows are quantized down to integers. It should be noted that FIG. 2A a visual example of quantization and the described systems herein may use a variety of quantization techniques to generate a quantized activation matrix comprising the required bitwidth and data format. Additionally, the various activation values displayed in FIGS. 2A, 2B, are in decimal format for illustrative purposes. However, it should be noted that actual activation values may be in binary, hexadecimal, etc., as appropriate for the given machine learning model. The quantized activation values may be stored in data formats such as matrices, tensors, or the like. In the example in FIG. 2A the activation values are stored within a quantized activation matrix 138. The quantized activation matrix 138 may be used by the NPU 124 in the computation for the hidden neural network later k+1, as described above.

FIG. 2B depicts an example of intra-layer mixed precision quantization including matrix reordering that may be used by various systems and techniques of the present disclosure. In the example described in FIG. 2B, the activation matrix 132 is generated by NPU 124 computation of the hidden neural network layer k, as described above in more detail. The activation matrix may undergo outlier determination 205, in the described example in FIG. 2B the quantization processing unit 160 may use outlier prediction data 152 to determine outlier rows contained within the activation matrix 132. It should be noted that the other methods for outlier determination discussed may be used in the place of the outlier prediction data 152. The quantization processing unit 160 may reorder the activation matrix 132 to group the outlier rows together within the matrix and the non-outlier rows together within the matrix. The quantization processing unit 160 may generate a reordered activation matrix 206. The reordered activation matrix 206 may have the outlier rows grouped together with no non-outlier rows in between them. As such the quantization process may be conducted on a block of rows (e.g., a block of 128 rows that have been determined to be outliers) instead of on individual rows. For example, in FIG. 2B, the quantization processing unit 160 may use the determined first quantization algorithm (as described above) to process the first two rows of the reordered activation matrix 206 together and then process the second two rows with the determined second quantization algorithm (as described above). Instead of processing the first row with the first quantization algorithm, the second row with the second quantization algorithm, the third row with the second quantization algorithm, and the fourth row with the first quantization algorithm. By reducing the number of switches between quantization algorithms the production of a quantized reordered activation matrix 208 may be less computationally demanding that producing a quantized unordered activation matrix.

In some examples, the production of a quantized reordered activation matrix 208 may allow for the implementation of specific memory buses for the sending of data from the on-device memory buffer(s) 140 to the NPU 124. For example, non-outlier rows may be quantized down to INT4, as such the non-outlier rows of the quantized reordered activation matrix 208 may use a low bitwidth memory bus 210 (e.g., a 4-bit bus) to be moved from the on-device memory buffer(s) 140 to the NPU (e.g., NPU 124). The outlier rows may be quantized to INT8, as such the outlier rows of the quantized reordered activation matrix 208 may use a high bitwidth memory bus 212 (e.g., an 8-bit bus) to be moved from the on-device memory buffer(s) 140 to the NPU (e.g., NPU 126). For example, the quantized outlier rows may be sent, via an 8-bit memory bus (e.g., high bitwidth memory bus 212), to a neural processing unit specifically configured to use 8-bit data in their computations (e.g., NPU 126). NPU 126 may include 8-bit MAC arrays for the computations associated with the processing of the neural network, such as tensor, matrix, and vector multiplications, or the like. Using an 8-bit MAC array may allow for efficient computation of the 8-bit values, without having to use multiple computational steps. The quantized non-outlier rows may be sent, via a 4-bit memory bus (e.g., low bitwidth memory bus 210), to a neural processing unit specifically configured to use 4-bit data in their computations (e.g., NPU 124). For example, NPU 124 may include 4-bit MAC arrays for the computations associated with the processing of the neural network. In other examples, the high bitwidth data and the low bitwidth data may be used by a single NPU (e.g., 124). In this case a memory bus may use time-based multiplexing to allow for the traversal of the low bitwidth quantized non-outlier rows (e.g., 4-bit) and the high bitwidth quantized outlier rows (e.g., 8-bit) through a memory bus in an efficient manner to NPU 124 for computation. The use of the time-based multiplexing may allow for the different data types to be sent in specific time slots to NPU 124. NPU 124, for example, may include 4-bit MAC arrays for the computations associated with the inference of a neural network. The 8-bit values may be split into two 4-bit values for computation using the 4-bit MAC arrays of NPU 124. Each 4-bit split value may be multiplied by its corresponding operand in the MAC array and the outputs may be accumulated together to produce an 8-bit output. Splitting the 8-bit values into 4-bit values may allow for 8-bit values to be used in computations assigned to a 4-bit MAC array. In various examples, the quantized reordered activation matrix 208 may be stored in the activation buffer. In these cases, the high bitwidth memory bus 212 and the low bitwidth memory bus 210 may be in the activation buffer access unit 120 from the activation buffer to the NPU 124. The quantized reordered activation matrix 208 may be used by the NPU 124 in the computation for the hidden neural network layer k+1. As described above in more detail, the computation for the generation of an activation matrix for a hidden layer of a neural network includes the multiplication of an input (e.g., quantized reordered activation matrix 208) with summed weights for each node within the layer. The computation for a hidden layer of a neural network may be conducted by a NPU (e.g., NPU 124, 126, and 128) using a MAC array. In a case where the quantization processing unit 160 generates a quantized reordered activation matrix 208, the weight matrix may be reordered to corresponding to the quantized reordered activation matrix 208. The reordering of the weight matrix ensures that the correct weights and activation values are used in the computation of the node activation values in next layer of the neural network (e.g., hidden neural network layer k+1).

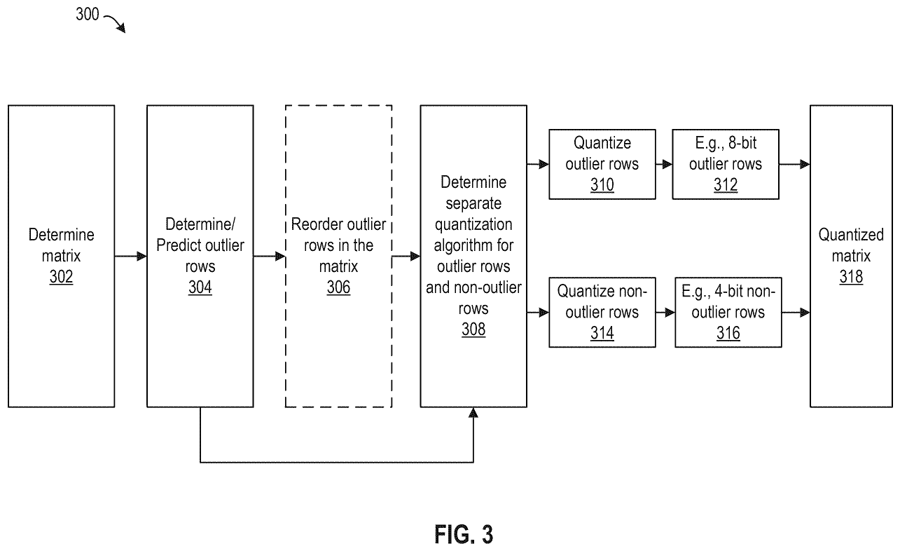

FIG. 3 depicts an example process 300 for intra-layer mixed precision quantization, in accordance with various examples of the present disclosure. The actions of the process 300 may represent a series of instructions comprising computer readable machine code executable by a processing unit of an image signal processor, although various operations may be implemented in hardware. In various examples, the computer readable machine codes may be comprised of instructions selected from a native instruction set of the processor(s) and/or operating system of the computing device.

Processing may start at action 302 at which an activation matrix and/or a weight matrix may be determined by the compute engine 116. The matrix may be stored in the on-device memory buffer(s) 140 (e.g., SRAM). Processing may continue at action 304 at which the quantization processing unit 160 may determine and/or predict outlier rows within the matrix. In the case of a weight matrix the outlier row determination may be based on the outlier rows determined in the activation matrix, to allow for the same bitwidth for weight and activation values. The outlier prediction and/or determination may allow for the optional action 306 depending on the specific implementation of the quantization processing unit 160 and the intra-layer multi precision quantization process. At action 306 the quantization processing unit 160 may reorder the matrix based on the determination and/or the prediction of outlier rows. In an instance where the matrix is a weight matrix the reordering may be based on the prediction of outlier rows of the activation matrix. The reordering of the weight matrix using the prediction of outlier rows of the activation matrix ensures that the layout of both the activation and weight matrices are aligned, allowing for the appropriate computations to occur. The generated reordered matrix may comprise of a group of outlier rows together in the matrix followed by a group of non-outlier rows grouped together in the matrix. After the optional reordering, the process may continue at action 308 with either a matrix or a reordered matrix. The quantization processing unit 160 may determine, based on instructions and the implementation of the system, the required quantization algorithms for the outlier and non-outlier rows. In various examples, the quantization algorithms may be determined based on the systems required input bitwidth and data format. In some embodiments, the system may determine based on the input the required bitwidth and data format for processing the input and generating an accurate response.

The process may continue at action 310 at which the quantization processing unit 160 may run the selected quantization algorithm on the outlier rows generating, for example, 8-bit outlier rows 312. The quantization processing unit may also run the selected quantization algorithm on the non-outlier rows 314, generating, for example, 4-bit non-outlier rows 316. The quantized 8-bit rows and the quantized 4-rows may be stored in a quantized matrix 318. In an implementation of the system in which reordering of the matrix is conducted the quantization activation matrix will be in same order as the reordered activation matrix.

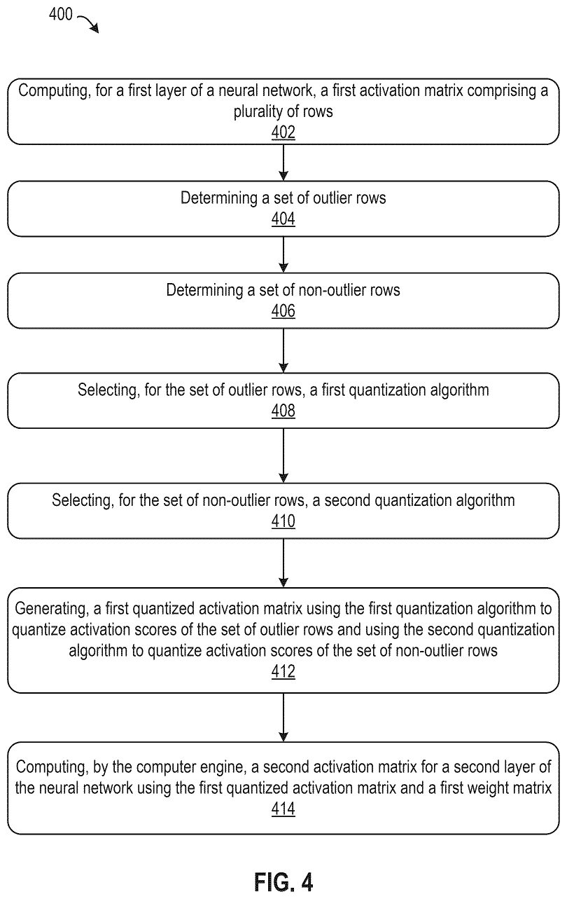

FIG. 4 depicts an example process 400 for intra-layer mixed precision quantization, in accordance with various aspects of the present disclosure. The actions of the process 400 may represent a series of instructions comprising computer readable machine code executable by a processing unit of a speech processing-enabled device, although various operations may be implemented in hardware. In various examples, the computer readable machine codes may be comprised of instructions selected from a native instruction set of the processor(s) and/or an operating system of the computing device.

Process 400 may begin at action 402, at which a first activation matrix is computed. The activation matrix may be comprised of rows of activation values that comprise of activation values for specific nodes generated by a first layer of a neural network computed by a processor (e.g., NPU 124). In some examples, the activation values may be computed using the activation values of the previous layer within the neural network. The computation of the activation score may comprise activation values of the previous layer multiplied by the sum of associated weights. The addition of bias and transformation of the data through an activation function. This may be done for every node within the hidden layer of a neural network. In some examples, the activation matrix may be generated for the initial layer of the neural network with input data in place of the activation values. The activation matrix computed may be stored in the on-device memory buffer(s) of the hardware accelerator (e.g., on-device memory buffer(s) 140, such as SRAM) and/or other storage.

Processing may continue at action 404, at which a set of outlier rows are determined. For example, the first activation matrix may comprise 50,000 activation values organized in 5,000 rows of which 128 may be classified as outliers. The number of outlier rows may be predetermined by the system, based on the implementation of the neural network, and stored as instructions. The quantization processing unit 160 may determine outlier rows from the activation matrix. In some examples, outlier rows may be determined based on the accumulated activation score of each row, using an adder circuit 134 to compute the total of the activation values across the row. The quantization processing unit 160 may determine the 128 highest rows accumulated activation values and classify these rows as outlier rows. In other examples, outlier rows may be determined based on the maximum value of each row. The maximum value of each row may be determined using a comparator circuit. The quantization processing unit 160 may determine the 128 highest row maximum value and classify these rows as outliers. In some examples, the determination of outlier rows may be based on outlier prediction data 152. Outlier prediction data 152 may contain predictions for the outlier rows for each layer of the neural network. The outlier prediction data 152 may be generated by an external system based on the processing of the neural network.

The processing may continue at action 406, at which a set of non-outlier rows are determined. For example, the first activation matrix may comprise 50,000 activation values organized in 5,000 rows of which 4,872 may be classified as non-outliers. The number of non-outlier rows may be predetermined by the system, based on the implementation of the neural network, and stored as an instruction set. The quantization processing unit 160 may determine non-outlier rows based on the accumulated activation values of each row. The accumulated activation score may be determined using the adder circuit 134 to compute the total activation score across the row. The quantization processing unit may determine the lowest 4,872 row accumulated activation values and classify these rows as non-outliers. In other examples, the non-outlier rows may be classified based on the row maximum value, determined by a comparator circuit. The quantization processing unit 160 may classify the 4,872 lowest row maximums as outlier rows. In various examples, the determination of non-outlier rows may be based on outlier prediction data 152. The outlier prediction data 152 may contain the predictions for the outlier rows for each layer of the neural network. The quantization processing unit 160 may use the prediction of outlier rows to determine which rows are non-outliers by classifying rows not contained within the outlier prediction data 152 as non-outliers.

The processing may continue at action 408, at which a first quantization algorithm, for the set of non-outlier rows, may be selected. For example, the intra-layer mixed precision quantization instructions may include the required bitwidth of 8-bit for the outlier rows. The activation matrix may comprise of activation values in the FP16 format. The quantization processing unit 160 may select a first quantization algorithm that may convert FP16 data into INT8 data. In some examples, the intra-layer mixed precision instruction set may include the required bitwidth of 4-bit for the outlier rows. In this case the quantization processing unit 160 may select a first quantization algorithm that may convert FP16 data into INT4 data. The quantization processing unit 160 may have the ability to select from a variety of quantization algorithms based on the implementation of the machine learning accelerator 100. For example, if the machine learning accelerator 100 is implemented on a mobile computing device (e.g., a mobile phone) the intra-layer mixed precision quantization instructions may limit the outlier bitwidth to 4-bit and the non-outlier bitwidth to 2-bit. Limiting the bitwidth may reduce accuracy of the model but may improve compute performance that may be limited on a mobile computing device.

The processing may continue at action 410, at which a second quantization algorithm, for the set of non-outlier rows, may be selected. For example, the intra-layer mixed precision quantization instructions may include the required bitwidth of 4-bit for the non-outlier rows. The activation matrix may comprise of activation values in the FP16 format. The quantization processing unit 160 may select a second quantization algorithm that may convert FP16 data into INT8 data. In some examples, the intra-layer mixed precision instructions may include the required bitwidth of 2-bit for the non-outlier rows. In this case the quantization processing unit 160 may select a second quantization algorithm that may convert FP16 data into INT2 data.

The processing may continue at action 412, at which a first quantized activation matrix is generated using the first quantization algorithm to quantize activation values of the set of outlier rows and using the second quantization algorithm to quantize activation values of the set of non-outlier rows. For example, the first quantization algorithm may quantize FP16 activation score data into INT8 data, and the second quantization algorithm may quantize FP16 activation score data into INT4 data. The generated mixed quantized activation values may be stored in a quantized activation matrix, wherein the data is in the same position as the first activation matrix. In some examples, the first activation matrix may be reordered prior to quantization. In an instance where the activation matrix is reordered the quantization activation matrix will have the data positioned the same as in the reordered activation matrix.

The processing may continue at action 414, at which a second activation matrix for a second layer of the neural network may be computed using the first quantized activation matrix and a first weight matrix. For example, the quantized activation matrix may be stored in on-device memory buffer(s) 140 and/or in activation buffer. The quantized activation matrix may be used by the processor (e.g., NPU 124) in the computation for the second layer of the neural network. The processor may compute activation values for each node in the second layer of the neural network. The computation of activation score may include multiplying the activation score of the node with the sum of the weights associated with the node contained within the first weight matrix. In some examples, the output of the processor computing the second layer activation values may be in the FP16.

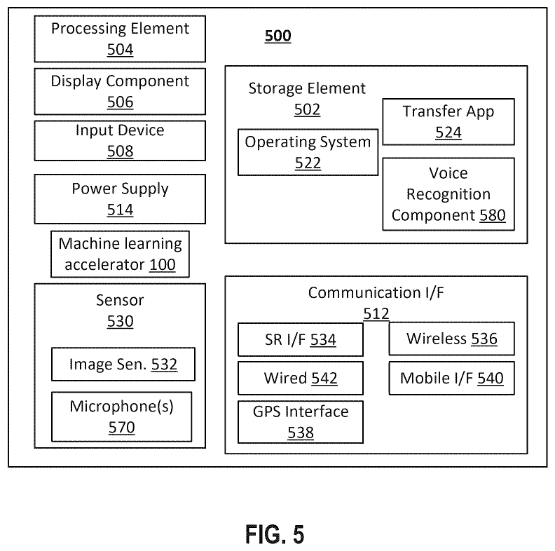

FIG. 5 is a block diagram showing an example architecture 500 of a network-connected device, such as an apparatus that may include the machine learning accelerator 100. In various examples, it may be advantageous to deploy the machine learning accelerator 100 in network edge devices and/or resource constrained devices (such as a device including all or some portion of the components of architecture 500) as the machine learning accelerator 100 may lower computational requirements for model execution (e.g., for machine learning model inference).

It will be appreciated that not all devices will include all of the components of the architecture 500 and some user devices may include additional components not shown in the architecture 500. The architecture 500 may include one or more processing elements 504 for executing instructions and retrieving data stored in a storage element 502. The processing element 504 may comprise at least one processor. Any suitable processor or processors may be used. For example, the processing element 504 may comprise one or more digital signal processors (DSPs). In some examples, the processing element 504 may be effective to determine a wakeword and/or to stream audio data to a speech processing system. The storage element 502 can include one or more different types of memory, data storage, or computer-readable storage media devoted to different purposes within the architecture 500. For example, the storage element 502 may comprise flash memory, random-access memory, disk-based storage, etc. Different portions of the storage element 502, for example, may be used for program instructions for execution by the processing element 504, storage of images or other digital works, and/or a removable storage for transferring data to other devices, etc.

The storage element 502 may also store software for execution by the processing element 504. An operating system 522 may provide the user with an interface for operating the computing device and may facilitate communications and commands between applications executing on the architecture 500 and various hardware thereof. A transfer application 524 may be configured to receive images, audio, and/or video from another device (e.g., a mobile device, image capture device, and/or display device) or from an image sensor 532 and/or microphone 570 included in the architecture 500. In some examples, the transfer application 524 may also be configured to send the received voice requests to one or more voice recognition servers.

When implemented in some user devices, the architecture 500 may also comprise a display component 506. The display component 506 may comprise one or more light-emitting diodes (LEDs) or other suitable display lamps. Also, in some examples, the display component 506 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 506 may be effective to display content determined provided by a skill executed by the processing element 504 and/or by another computing device. In some examples, the display component 506 and/or one or more speakers (not shown) may be effective to output an indication that unconsumed notifications (e.g., voice notifications) are pending. In some cases, there may be an indicator light effective to provide such an indication. In addition, speakers of the architecture 500 may output the voice notification audio upon receiving a user command to consume or “read” the voice notifications.

The architecture 500 may also include one or more input devices 508 operable to receive inputs from a user. The input devices 508 can include, for example, a push button, touch pad, touch screen, wheel, joystick, keyboard, mouse, trackball, keypad, light gun, game controller, or any other such device or element whereby a user can provide inputs to the architecture 500. These input devices 508 may be incorporated into the architecture 500 or operably coupled to the architecture 500 via wired or wireless interface. In some examples, architecture 500 may include a microphone 570 or an array of microphones for capturing sounds, such as voice requests. Voice recognition component 580 may interpret audio signals of sound captured by microphone 570. In some examples, voice recognition component 580 may listen for a “wakeword” to be received by microphone 570. Upon receipt of the wakeword, voice recognition component 580 may stream audio to a voice recognition server for analysis, such as a speech processing system. In various examples, voice recognition component 580 may stream audio to external computing devices via communication interface 512.

When the display component 506 includes a touch-sensitive display, the input devices 508 can include a touch sensor that operates in conjunction with the display component 506 to permit users to interact with the image displayed by the display component 506 using touch inputs (e.g., with a finger or stylus). The architecture 500 may also include a power supply 514, such as a wired alternating current (AC) converter, a rechargeable battery operable to be recharged through conventional plug-in approaches, or through other approaches such as capacitive or inductive charging.

The communication interface 512 may comprise one or more wired or wireless components operable to communicate with one or more other computing devices. For example, the communication interface 512 may comprise a wireless communication module 536 configured to communicate on a network, such as a computer communication network, according to any suitable wireless protocol, such as IEEE 802.11 or another suitable wireless local area network (WLAN) protocol. A short range interface 534 may be configured to communicate using one or more short range wireless protocols such as, for example, near field communications (NFC), Bluetooth, Bluetooth LE, etc. A mobile interface 540 may be configured to communicate utilizing a cellular or other mobile protocol. A Global Positioning System (GPS) interface 538 may be in communication with one or more earth-orbiting satellites or other suitable position-determining systems to identify a position of the architecture 500. A wired communication module 542 may be configured to communicate according to the USB protocol or any other suitable protocol.

The architecture 500 may also include one or more sensors 530 such as, for example, one or more position sensors, image sensors, and/or motion sensors. An image sensor 532 is shown in FIG. 5. An example of an image sensor 532 may be a camera configured to capture color information, image geometry information, and/or ambient light information.

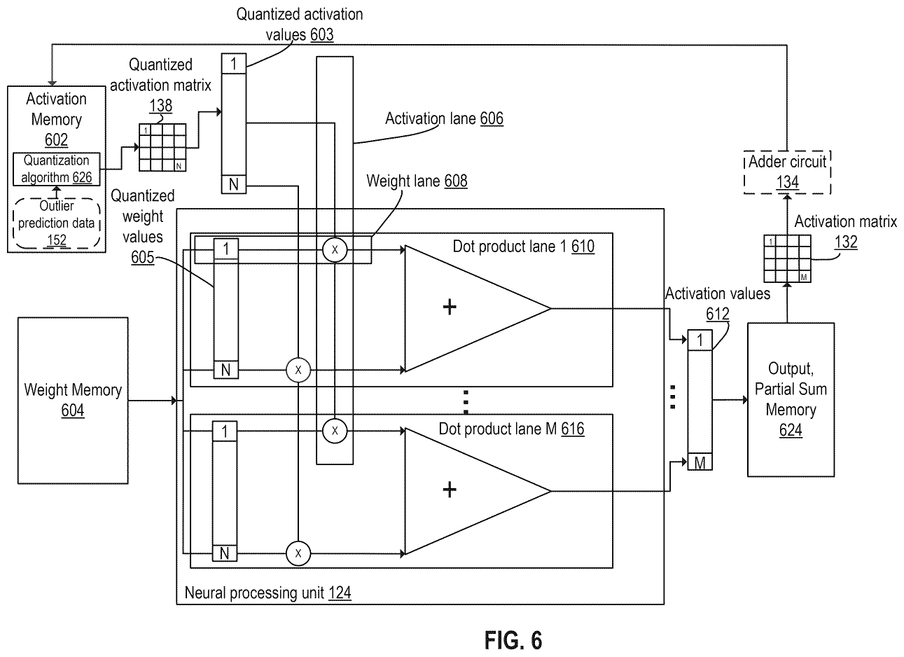

FIG. 6 depicts an example of the neural processing unit of FIG. 1 that may use the quantized activation matrix in computational tasks, in accordance with various aspects of the present disclosure. Quantized activation matrix 138 may be converted into a vector containing the quantized activation values 603 and loaded into the NPU 124 for processing. The quantized activation values 603 may be in the activation lane 606 within the NPU 124. The quantized weight values 605 may be loaded into the weight lane 608 of the NPU 124 from the weight memory 604. The NPU 124 may include any number of dot product lanes (e.g., dot product lane 1 610, . . . , dot product lane M 616). In the dot product lane 1 610 the quantized activation values in the activation lane 606 may be multiplied by the corresponding quantized weight values 605 in the weight lane 608. After the multiplication of the weights and the quantized activation values in the dot product lane 1 610 the output has the respective bias added. After the bias is added the output goes through a non-linear operation such as a non-linear activation function. The output of the non-linear activation function is the activation score for the node of this layer of the neural network. The activation values 612 from nodes within the layer are compiled into a vector and stored in the output, partial sum memory 624 until all the computations for the layer are completed. The vector of the activation values may be converted into an activation matrix 132. The adder circuit 134 may compute the total activation score for each row of the activation matrix 132, which may be used to determine the first of rows and the second set of rows. The activation matrix 132 may be loaded into the activation memory 602. After being stored the activation matrix 132 may undergo intra-layer mixed precision quantization, by selecting the appropriate quantization algorithms 626 for the first and second set of rows, generating a quantization activation matrix 138 that may be used in the computation conducted by the NPU 124 for the next layer of the neural network.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon applying one or more data signals, application specific integrated circuits having appropriate logic gates, or other components, etc. Such technologies are generally well known by those of ordinary skill in the art and consequently, are not described in detail herein.

As used herein (e.g., including in the claims of the application), the terms “first”, “second”, and so forth, do not necessarily imply a particular order of events or elements, but are used to distinguish individual elements from one another. For example, the language a “first layer” of a machine learning model does not necessarily mean that the layer is the initial layer of the model. Instead, the adjective “first” may merely be intended to distinguish the layer from other layers such as a “second” layer. In fact, in various examples, the second layer may precede the first layer and there may be any number of intervening layers between the “first layer” and the “second layer.”

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or other type of application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A system comprising:
a neural network accelerator apparatus comprising:
one or more processors;
a compute engine; and
one or more computer-readable media comprising static random access memory (SRAM) and dynamic random access memory (DRAM), the one or more computer-readable media storing processor-executable instructions which, when executed using the one or more processors, perform operations comprising:
computing, for a first layer of a neural network, a first activation matrix, wherein the first activation matrix comprises a first plurality of rows, wherein a first row of the first plurality of rows comprises a plurality of activation values;
determining, based on the plurality of activation values, a set of outlier rows;
determining, based on the plurality of activation values, a set of non-outlier rows;
selecting, for the set of outlier rows, a first quantization algorithm, wherein the first quantization algorithm generates output having a first bitwidth;
selecting, for the set of non-outlier rows, a second quantization algorithm, wherein the second quantization algorithm generates output having a second bitwidth, wherein the second bitwidth is less than the first bitwidth;
generating, a first quantized activation matrix using the first quantization algorithm to quantize activation values of the set of outlier rows and using the second quantization algorithm to quantize activation values of the set of non-outlier rows; and
computing, by the compute engine, a second activation matrix for a second layer of the neural network using the first quantized activation matrix and a first weight matrix.

2. The system of claim 1, further comprising an adder circuit, wherein the one or more computer-readable media stores further processor-executable instructions which, when executed using the one or more processors, perform further operations comprising:
computing, using the adder circuit, a set of accumulated activation values comprising a accumulated activation value for each row of the first activation matrix; and
generating a ranking of the set of accumulated activation values, wherein determining the set of outlier rows is based on the ranking of the set of accumulated activation values.

3. The system of claim 2, further comprising a first memory bus and a second memory bus, wherein the one or more computer-readable media stores further processor-executable instructions which, when executed using the one or more processors, perform further operations comprising:
generating, an outlier matrix, wherein the outlier matrix comprises the set of outlier rows from the first activation matrix;
generating, a non-outlier matrix, wherein the non-outlier matrix comprises the set of non-outlier rows from the first activation matrix;
generating, by quantizing the outlier matrix using the first quantization algorithm, a quantized outlier matrix;
generating, by quantizing the non-outlier matrix using the second quantization algorithm, a quantized non-outlier matrix;
sending, by the first memory bus, the quantized outlier matrix to the second layer of the neural network, wherein the first memory bus has a first bitwidth; and
sending, by the second memory bus, the quantized non-outlier matrix to the second layer of the neural network, wherein the second memory bus has a second bitwidth, wherein the second bitwidth is lower than the first bitwidth, wherein the first quantized activation matrix comprises the quantized outlier matrix and the quantized non-outlier matrix.

4. A system comprising:
a neural network accelerator apparatus comprising:
one or more processors; and
one or more computer-readable media storing processor executable instructions which, when executed using the one or more processors, perform operations comprising:
determining, for a first layer of a neural network, a first tensor wherein the first tensor comprises a plurality of rows;
selecting, from the first tensor, a first set of rows from among the plurality of rows;
selecting, from the first tensor, a second set of rows from among the plurality of rows;
selecting, for the first set of rows, a first quantization algorithm associated with a first bitwidth;
selecting, for the second set of rows, a second quantization algorithm associated with a second bitwidth;
generating, a quantized first tensor by quantizing values of the first set of rows using the first quantization algorithm and quantizing values of the second set of rows using the second quantization algorithm; and
computing an output for a second layer of the neural network using the quantized first tensor.

5. The system of claim 4 further comprising a comparator circuit, wherein the one or more computer-readable media stores further processor-executable instructions which, when executed using the one or more processors, perform further operations comprising:
determining, using the comparator circuit, a first maximum value for a first row of the first tensor;
determining, using the comparator circuit, a second maximum value for a second row of the first tensor;
determining, by the comparator circuit, that the first maximum value is greater than the second maximum value; and
determining, based on the first maximum value being greater than the second maximum value, the first set of rows as outlier rows for the first tensor, wherein the first row is included in the first set of rows.

6. The system of claim 4, wherein the one or more computer-readable media stores further processor-executable instructions which, when executed using the one or more processors, perform further operations comprising:
predicting the first set of rows using a first machine learning model.

7. The system of claim 6, wherein the one or more computer-readable media stores further processor-executable instructions which, when executed using the one or more processors, perform further operations comprising;
determining, using the first machine learning model, the first bitwidth for the first set of rows, wherein the first bitwidth is determined based on compliance with a first performance metric of the neural network; and
determining, using the first machine learning model, the second bitwidth for the second set of rows, wherein the second bitwidth is determined based on compliance with the first performance metric of the neural network.

8. The system of claim 4, further comprising a first memory bus and a second memory bus, wherein the one or more computer-readable media stores further processor-executable instructions which, when executed using the one or more processors, perform further operations comprising:
generating a reordered tensor based on the first tensor, wherein the reordered tensor comprises the first set of rows grouped together in the reordered tensor, and the second set of rows grouped together in the reordered tensor, wherein a quantized first tensor comprises the reordered tensor;
sending, using the first memory bus, values from the first set of rows to the second layer of the neural network, wherein the first memory bus has the first bitwidth; and
sending, using the second memory bus, values from the second set of rows to the second layer of the neural network, wherein the second memory bus has the second bitwidth.

9. The system of claim 8, wherein the one or more computer-readable media stores further processor-executable instructions which, when executed using the one or more processors, perform further operations comprising reordering a first weight tensor based on the reordered tensor, wherein the first weight tensor is reordered prior to computing the output for the second layer of the neural network.

10. The system of claim 4, further comprising an adder circuit, wherein the one or more computer-readable media stores further processor-executable instructions which, when executed using the one or more processors, perform further operations comprising:
computing, using the adder circuit, a set of accumulated values comprising a respective accumulated value for each row of the first tensor; and
generating a ranking of the set of accumulated values, wherein selecting the first set of rows is based on the ranking of the set of accumulated values.

11. The system of claim 4, wherein the first set of rows comprises a set of outlier rows wherein, the set of outlier rows are determined to be outliers from remaining rows in the first tensor.

12. The system of claim 11, wherein the one or more computer-readable media stores further processor-executable instructions which, when executed using the one or more processors, perform further operations comprising:
selecting, the first quantization algorithm that generates a high bitwidth representation of the set of outlier rows;
selecting, the second quantization algorithm that generates a low bitwidth representation of the second set of rows comprising a set of non-outlier rows;
generating, the high bitwidth representation of the set of outlier rows; and
generating, the low bitwidth representation of the set of non-outlier rows, wherein the first set of rows comprises a set of outlier rows, generating a quantized first tensor, using the high bitwidth representation of the set of outlier rows and the low bitwidth representation of the set of non-outlier rows.

13. A method comprising:
computing, for a first layer of a neural network, a first tensor wherein the first tensor comprises a plurality of rows;
selecting, from the first tensor, a first set of rows from among the plurality of rows;
selecting, from the first tensor, a second set of rows from among the plurality of rows;
selecting, for the first set of rows, a first quantization algorithm associated with a first bitwidth;
selecting, for the second set of rows, a second quantization algorithm associated with a second bitwidth;
generating, a quantized first tensor by quantizing values of the first set of rows using the first quantization algorithm and quantizing values of the second set of rows using the second quantization algorithm; and
computing an output for a second layer of the neural network using the quantized first tensor.

14. The method of claim 13 comprising:
determining, using a comparator circuit, a first maximum value for a first row of the first tensor;
determining, using the comparator circuit, a second maximum value for a second row of the first tensor; and
determining, based on the first maximum value being greater that the second maximum value, the first set of rows as outlier rows for the first tensor, wherein the first row is included in the first set of rows.

15. The method of claim 13 comprising predicting the first set of rows using a first machine learning model.

16. The method of claim 15 comprising:
determining, using the first machine learning model, the first bitwidth for the first set of rows, wherein the first bitwidth is determined based on compliance with a first performance metric of the neural network; and
determining, using the first machine learning model, the second bitwidth for the second set of rows, wherein the second bitwidth is determined based on compliance with the first performance metric of the neural network.

17. The method of claim 13, comprising:
generating a reordered tensor based on the first tensor, wherein the reordered tensor comprises the first set of rows grouped together in the reordered tensor, and the second set of rows grouped together in the reordered tensor, wherein a quantized first tensor comprises the reordered tensor;
sending, using a first memory bus, values from the first set of rows, to the second layer of the neural network, wherein the first memory bus has the first bitwidth; and
sending, using a second memory bus, values from the second set of rows, to the second layer of the neural network, wherein the second memory bus has the second bitwidth.

18. The method of claim 17, comprising reordering a first weight tensor based on the reordered tensor, wherein the first weight tensor is reordered prior to computing the output for the second layer of the neural network.

19. The method of claim 13, comprising:
computer, using an adder circuit, a set of accumulated values comprising a respective accumulated value for each row of the first tensor; and
generating a ranking of the set of accumulated values, wherein selecting the first set of rows is based on the ranking of the set of accumulated values.

20. The method of claim 13, comprising:
selecting, the first quantization algorithm that generates a high bitwidth representation of the first set of rows;
selecting, the second quantization algorithm that generates a low bitwidth representation of the second set of rows;
generating, the high bitwidth representation of the first set of rows; and
generating, the low bitwidth representation of the second set of rows, wherein the first set of rows comprises a set of outlier rows and the second set of rows comprises a set of non-outlier rows, generating the quantized first tensor, using the high bitwidth representation of the set of outlier rows and the low bitwidth representation of the set of non-outlier rows.

21. The method of claim 13, wherein the computing the output for the second layer of the neural network using the quantized first tensor comprises:
sending, using a first memory bus, a first row of the quantized first tensor to a first neural processing unit, wherein the first row of the quantized first tensor comprises values quantized using the first quantization algorithm; and
sending, using a second memory bus, a second row of the quantized first tensor to a second neural processing unit, wherein the second row of the quantized first tensor comprises values quantized using the second quantization algorithm.

22. The method of claim 13, wherein the computing the output for the second layer of the neural network using the quantized first tensor comprises:
sending, using a first memory bus, a first row of the quantized first tensor to a first neural processing unit during a first time slot, wherein the first row of the quantized first tensor comprises values quantized using the first quantization algorithm; and
sending, using the first memory bus, a second row of the quantized first tensor to a second neural processing unit during a second time slot, wherein the second row of the quantized first tensor comprises values quantized using the second quantization algorithm.
